(19) United States
(12) Patent Application Publication
(10) Pub. No.: US 2016/0350782 A1
(43) Pub. Date: Dec. 1, 2016

(54) METHOD AND SYSTEM FOR RED ENVELOPE REWARD ADVERTISEMENT FOR SOCIAL NETWORKING SYSTEMS

(71) Applicant: John Wang, Alpharetta, GA (US)

(72) Inventor: John Wang, Alpharetta, GA (US)

(21) Appl. No.: 15/150,361

(22) Filed: May 9, 2016

Related U.S. Application Data
(60) Provisional application No. 62/162,671, filed on May 16, 2015.

(51) Int. Cl. G06Q 30/02; G06Q 20/36; G06Q 50/00

(52) U.S. Cl. CPC G06Q 30/0215; G06Q 30/0222; G06Q 50/01; G06Q 30/0277; G06Q 20/36

(57) ABSTRACT

One aspect of the invention relates to a method for a red envelope reward advertisement. The method includes creating a red envelope reward advertisement containing advertisement content and a red envelope, publishing the red envelope reward advertisement to a social network system, identifying users of the social network system who access and view the advertisement content of the red envelope reward advertisement, and rewarding each user who accesses and views the advertisement content from the red envelope of the red envelope reward advertisement.

### CROSS-REFERENCE TO RELATED PATENT APPLICATION

This application claims priority to and the benefit of, pursuant to 35 U.S.C. §119(e), U.S. provisional patent application Ser. No. 62/162,671, filed May 16, 2015, which is incorporated herein in its entirety by reference.

### BACKGROUND

Traditionally, a red envelope is a monetary gift which is given during holidays or special occasions such as weddings, graduation or the birth of a baby in Chinese and other East Asian societies. The monetary gift is usually put into a red color envelope and given to people. Outside of China, similar customs exist across parts of South East Asia and many other countries with a sizable ethnic Chinese population. A red envelope can also called red packet, lai sec, lishi, lucky money, or hongbao.

Chinese companies such as Tencent Holding Ltd. and Alibaba Group Holding Ltd.have developed smart phone apps to enable people to send an electronic red envelope via a mobile device such as a smart phone in a virtual form. The electronic red envelope contains monetary gifts like the traditional red envelope. When a user opens the red envelope on his/her mobile device, the gift money of the red envelope will be deposited to the user's e-wallet, or bank account, or the like.

A social networking system is a service, a website or an application that enables users to communicate with each other by posting information, comments, messages, images, form links and associations like group. For example, a social networking service can allow a user to send messages to particular or multiple users, group users in user lists, friends lists, or other user groups, post content including text, images, video sequences, audio sequences or recordings, or other types of content for access by designated sets of users of the social networking service. Such social networking systems are accessible to users through smart phones, tablets, computers, PDAs, wearable or other mobile devices.

WeChat® (or “weixin” in Chinese) is one of the most popular social networking platforms in China, which has, among other things, the features of both WhatsApp® and Facebook®. WeChat® provides services such as text messaging, hold-to-talk voice messaging, broadcast (one-to-many) messaging, video conferencing, sharing of photographs and videos, etc. WeChat® allows user to create user groups and share information with groups and friend circles. In the past couple of years, WeChat® red envelopes, a service of WeChat®, have become very popular. People can send one or more red envelopes electronically to individual, and/or user groups in a social networking platformsuch as WeChat®. WeChat® red envelopes are used not only in traditional holidays or special occasions, but also in any occasions that people feel proper.

There are two types of WeChat® red envelopes. One is a regular red envelope (or “pu tong hongbao” in Chinese). For this type of red envelopes, a user can specify the amount of money to give out therein, and can send the red envelope an individual, or a WeChat® group, recipients will receives an equal amount of money. The other is a red envelope lucky draw (or “pin shou qi hongbao” in Chinese). Similar to the regular red envelope a user can specify the amount of money to give out therein, and can send the red envelope an individual, or a WeChat® group. However, for the red envelope lucky draw, recipients will receive an amount of money randomly assigned by the WeChat® red envelope based on the information user entered at the time of red envelope creation.

The traditional red envelopes and the existing electronic red envelopes only serve as monetary gifts. Therefore, a heretofore unaddressed need exists in the art to address the aforementioned deficiencies and inadequacies.

### SUMMARY

The objectives of the present invention are to provide method, system, application and non-transitory computer-readable medium for distributing advertisements and rewarding viewers of the advertisements in the form of red envelopes for a social networking system.

In one aspect, the invention relates to a method for a red envelope reward advertisement. In one embodiment, the method comprises creating a red envelope reward advertisement containing advertisement content and a red envelope, publishing the red envelope reward advertisement to a social network system, identifying users of the social network system who access and view the advertisement content of the red envelope reward advertisement, and rewarding each user who accesses and views the advertisement content from the red envelope of the red envelope reward advertisement.

In one embodiment, the advertisement content comprises at least one of one or more logos, one or more trademarks, one or more pictures, one or more audios, one or more videos, one or more depictions, and one or more website links, referring to one or more products or services.

In one embodiment, the red envelope comprises at least one type of rewards including cashes, points, discount coupons, gift cards, free products or services, IOU, Bitcoin®, virtual money, and the like, and an amount of rewards for each user who access and view the advertisement content.

In one embodiment, the red envelope reward advertisement contains a notice of which the red envelope is rewarded only to users who access and view the advertisement content.

In one embodiment, the step of rewarding each user who accesses and views the advertisement content comprises rewarding each user who accesses and views the advertisement content with the amount of rewards.

In one embodiment, the step of rewarding each user who accesses and views the advertisement content comprises depositing the amount of rewards to an account or e-wallet of the user.

In one embodiment, the method further comprising rewarding each user who places a purchase order after accessing and viewing the advertisement content.

In one embodiment, the method further comprises sending information of user access and view and user feedback of the red envelope reward advertisement to an advertiser of the red envelope reward advertisement, by a service provider of the social network system.

In one embodiment, the method further comprises rewarding a service provider of the social network system when a user accesses and views the advertisement content.

In one embodiment, the step of creating the red envelope reward advertisement is performed by an advertiser, in a client device.

In another aspect, the invention relates to a system for a red envelope reward advertisement. In one embodiment, the system includes a storage medium, and one or more processors accessing the storage medium and operative to perform operations comprising creating a red envelope reward advertisement containing advertisement content and a red envelope; publishing the red envelope reward advertisement to a social network system; identifying users of the social network system who access and view the advertisement content of the red envelope reward advertisement; and rewarding each user who accesses and views the advertisement content from the red envelope of the red envelope reward advertisement.

In one embodiment, the advertisement content comprises at least one of one or more logos, one or more trademarks, one or more pictures, one or more audios, one or more videos, one or more depictions, and one or more website links, referring to one or more products or services.

In one embodiment, the red envelope comprises at least one type of rewards including cashes, points, discount coupons, gift cards, free products or services, IOU, Bitcoin®, virtual money, and the like, and an amount of rewards for each user who access and view the advertisement content.

In one embodiment, the red envelope reward advertisement contains a notice of which the red envelope is rewarded only to users who access and view the advertisement content.

In one embodiment, rewarding each user who accesses and views the advertisement content comprises rewarding each user who accesses and views the advertisement content with the amount of rewards.

In one embodiment, rewarding each user who accesses and views the advertisement content comprises depositing the amount of rewards to an account or e-wallet of the user.

In one embodiment, the operations further comprises rewarding each user who places a purchase order after accessing and viewing the advertisement content.

In one embodiment, the operations further comprises rewarding a service provider of the social network system when a user who accesses and views the advertisement content.

In one embodiment, the operation of further comprises sending information of user access and view and user feedback of the red envelope reward advertisement to an advertiser of the red envelope reward advertisement, by a service provider of the social network system.

In a further aspect, the invention related to a non-transitory computer-readable medium storing instructions which, when executed by one or more processors, cause a system to perform operations comprising creating a red envelope reward advertisement containing advertisement content and a red envelope; publishing the red envelope reward advertisement to a social network system; identifying users of the social network system who access and view the advertisement content of the red envelope reward advertisement; and rewarding each user who accesses and views the advertisement content from the red envelope of the red envelope reward advertisement.

The present invention, among other things, has significant advantages over the traditional red envelope and the existing electronic red envelope at least in the following aspects.

One advantage is that the present invention serves as a reward advertisement system. The traditional red envelope and the existing electronic red envelope only serve as monetary gifts. The present invention not only provides advertisements, but also provides rewards for people who view the advertisements. The traditional red envelope and the existing electronic red envelope only contain monetary gifts. According to the present invention, the rewards may include cash rewards, points, discount coupons, gift cards, free products or services, IOU, Bitcoin®, virtual money, etc.

Another advantage is that according to the present invention, the rewards are given in a red envelope form for viewing the advertisements. The conventional advertisements may provide rewards to viewers of advertisements, but they are not in the form of red envelopes. Conventionally, social network advertiser may provide rewards to viewers, but the rewards are given to people who give good reviews for their advertised products or services or sharing advertisements in their friend circles. However, according to the present invention, rewards are given to people who open the red envelope reward advertisement and view the advertisement. The advertiser does not pay rewards for the social network users who do not open the red envelope and view the advertisement. In case that no people view the advertisement, the advertiser pays no rewards. Thus, the present invention can reduce unnecessary advertisement expense for advertisers and improve the effectiveness of the advertisement in a social network environment.

Yet another advantage is that the present invention provides new methods and systems for social networking service providers and social networking group creators/managers to receive advertisement revenue. Conventionally, when social network users such as WeChat® users post advertisements directly to their social networking groups, the social networking service providers do not get advertisement revenue automatically. People who create or manage the social networking groups such as WeChae® groups do not receive advertisement revenue either. The present invention provides methods and systems for advertisers to pay the social networking system providers and social networking group creators and/or managers for their work automatically whenever social network users use red envelope reward advertisement to publish ads to social network users.

A further advantage is that the present invention enables advertisers to target particular social networking system users. By serving more relevant ads, advertisers increase the conversion rate of viewers of the ads to purchasers of the proposed goods or services; typically generate greater advertisement revenue compared to broad-based ads.

Yet a further advantage is that according to the present invention, the number of advertisement viewers, reward amount, and viewer feedback information, etc., can be collected and stored into database. Further analysis on the data may produce valuable information on viewer behaviors and help to evaluate and improve advertisement effectiveness.

These and other aspects of the present invention will become apparent from the following description of the preferred embodiment taken in conjunction with the following drawings, although variations and modifications therein may be affected without departing from the spirit and scope of the novel concepts of the present invention.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment. The drawings do not limit the present invention to the specific embodiments disclosed and described herein. The drawings are not necessarily to scale, emphasis instead being placed upon clearly illustrating the principles of the invention.

FIG. 1A is an example of a traditional red envelope given as a monetary gift.

FIG. 1B is an example of an existing electronic red envelope on a smart phone given as a monetary gift.

FIG. 1C is an exemplary embodiment of a red envelope reward advertisement according to the present invention.

FIG. 2 is a block diagram illustrating a red envelope reward advertisement is published through social networking system to its users, according to one embodiment of the present invention.

FIG. 3 is a flow diagram illustrating an example process that red envelope reward advertisement is created and distributed to social network users; social network users can view the advertisement and receive the rewards, according to one embodiment of the present invention.

FIG. 4 illustrates a flowchart of an exemplary process red envelope reward advertisement is created, configured and published in details, according to one embodiment of the present invention.

FIGS. 5A-5C illustrate an example of various advertisement types that red envelope reward advertisement system, method and apparatus can serve, according to one embodiment of the present invention, wherein FIG. 5A illustrate a first part of the example, FIG. 5B illustrate a second part of the example that continues FIG. 5A, and FIG. 5C illustrate a third part of the example that continues FIG. 5B.

FIG. 6 is a block diagram of an example of red envelope reward advertisement implementation with servers and fault protection method, according to one embodiment of the present invention.

### DETAILED DESCRIPTION

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the term “social networking service”, or “social networking system”, or “social networking platform”, can include a software and/or hardware system that facilitates user interactions, and can include a service implemented on a network system, including, but is not limited to, Facebook®, Linkedin®, Twitter®, WeChat®, Dingdingchong®, Weibo®, QQ®, line, Whatsup®, Instagram®, Google+®, etc.

As used herein, the term “user” refers to, but is not limited to, a social network user of a social networking system. The social network user is in communication with the social networking system wirely or wirelessly, and can be an individual, a game player, a company, or an entity. The term “advertiser”, as used herein, refers to, but is not limited to, a social network user who creates and publishes a red envelope reward advertisement. The “advertiser” can represent an individual, a company, a group, or an entity, to create and publish a red envelope reward advertisement, based on advertisement contents and information of red envelopes provided by the individual, the company, the group, or the entity. The term “viewer”, as used herein, refers to, but is not limited to, a social network user who receives the red envelope reward advertisement and views the advertisement content.

As used herein, the terms“step” and “block” refer to an operation or function to be performed and/or executed, and are exchangeable.

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. The described features, structures, or characteristics of the embodiment may be combined in any suitable manner in one or more embodiments. In the following description, numerous specific details are recited to provide a thorough understanding of embodiments of the invention. One skilled in the relevant art will recognize however, that the invention may be practiced without one or more of the specific details, or with other methods, components, materials, and so forth. In other instances, well-known structures, materials, or operations are not shown or described in detail to avoid obscuring aspects of the invention. Thus, embodiments of the present invention are not intended to be limited to the examples described herein and shown, but are to be accorded the scope consistent with the claims.

In one aspect, the invention relates to a method for a red envelope reward advertisement. In one embodiment, the method comprises creating a red envelope reward advertisement containing advertisement content and a red envelope, publishing the red envelope reward advertisement to a social network system, identifying users of the social network system who access and view the advertisement content of the red envelope reward advertisement, and rewarding each user who accesses and views the advertisement content from the red envelope of the red envelope reward advertisement. The social networking system is, but is not limited to, a social networking platform/service, such as WeChat®, Line, Facebook®, Whatsup®, etc.

In one embodiment, the advertisement content comprises at least one of one or more logos, one or more trademarks, one or more pictures, one or more audios, one or more videos, one or more depictions, and one or more website links, referring to one or more products or services.

In one embodiment, the red envelope comprises at least one type of rewards including cashes, points, discount coupons, gift cards, free products or services, IOU, bitcoin, virtual money, and the like, and an amount of rewards for each user who access and view the advertisement content.

In one embodiment, the red envelope reward advertisement contains a notice of which the red envelope is rewarded only to users who access and view the advertisement content.

In one embodiment, the step of rewarding each user who accesses and views the advertisement content comprises rewarding each user who accesses and views the advertisement content with the amount of rewards.

In one embodiment, the step of rewarding each user who accesses and views the advertisement content comprises depositing the amount of rewards to an account or e-wallet of the user.

In one embodiment, the method further comprising rewarding each user who places a purchase order after accessing and viewing the advertisement content.

In one embodiment, the method further comprises sending information of user access and view and user feedback of the red envelope reward advertisement to an advertiser of the red envelope reward advertisement, by a service provider of the social network system.

In one embodiment, the method further comprises rewarding a service provider of the social network system when a user accesses and views the advertisement content.

In one embodiment, the step of creating the red envelope reward advertisement is performed by an advertiser, in a client device. The client device can be any type of electronic devices being wirely or wirelessly communicable with the social networking system. The client device can be, but is not limited to, a mobile/cell phone, a smart phone, a smart watch, a personal digital assistant (PDA), a tablet, a laptop, a PC, a game player/box, a smart TV, a TV set top box or entertainment device, a media player, game device, wearable electronics, and the like.

In another aspect, the invention relates to a system for a red envelope reward advertisement. In one embodiment, the system includes a storage medium, and one or more processors accessing the storage medium and operative to perform operations comprising creating a red envelope reward advertisement containing advertisement content and a red envelope; publishing the red envelope reward advertisement to a social network system; identifying users of the social network system who access and view the advertisement content of the red envelope reward advertisement; and rewarding each user who accesses and views the advertisement content from the red envelope of the red envelope reward advertisement.

In one embodiment, the advertisement content comprises at least one of one or more logos, one or more trademarks, one or more pictures, one or more audios, one or more videos, one or more depictions, and one or more website links, referring to one or more products or services.

In one embodiment, the red envelope comprises at least one type of rewards including cashes, points, discount coupons, gift cards, free products or services, IOU, bitcoin, virtual money, and the like, and an amount of rewards for each user who access and view the advertisement content.

In one embodiment, the red envelope reward advertisement contains a notice of which the red envelope is rewarded only to users who access and view the advertisement content.

In one embodiment, rewarding each user who accesses and views the advertisement content comprises rewarding each user who accesses and views the advertisement content with the amount of rewards.

In one embodiment, rewarding each user who accesses and views the advertisement content comprises depositing the amount of rewards to an account or e-wallet of the user.

In one embodiment, the operations further comprises rewarding each user who places a purchase order after accessing and viewing the advertisement content.

In one embodiment, the operations further comprises rewarding a service provider of the social network system when a user who accesses and views the advertisement content.

In one embodiment, the operation of further comprises sending information of user access and view and user feedback of the red envelope reward advertisement to an advertiser of the red envelope reward advertisement, by a service provider of the social network system.

The method and system described herein may be implemented by one or more computer programs or applications executed by one or more processors. The computer programs or applications include processor-executable instructions that are stored on a non-transitory tangible computer readable medium. The computer programs or applications may also include stored data. Non-limiting examples of the non-transitory tangible computer readable medium are nonvolatile memory, magnetic storage, and optical storage. In one aspect, the invention related to a non-transitory computer-readable medium storing instructions which, when executed by one or more processors, cause a system to perform operations comprising creating a red envelope reward advertisement containing advertisement content and a red envelope; publishing the red envelope reward advertisement to a social network system; identifying users of the social network system who access and view the advertisement content of the red envelope reward advertisement; and rewarding each user who accesses and views the advertisement content from the red envelope of the red envelope reward advertisement.

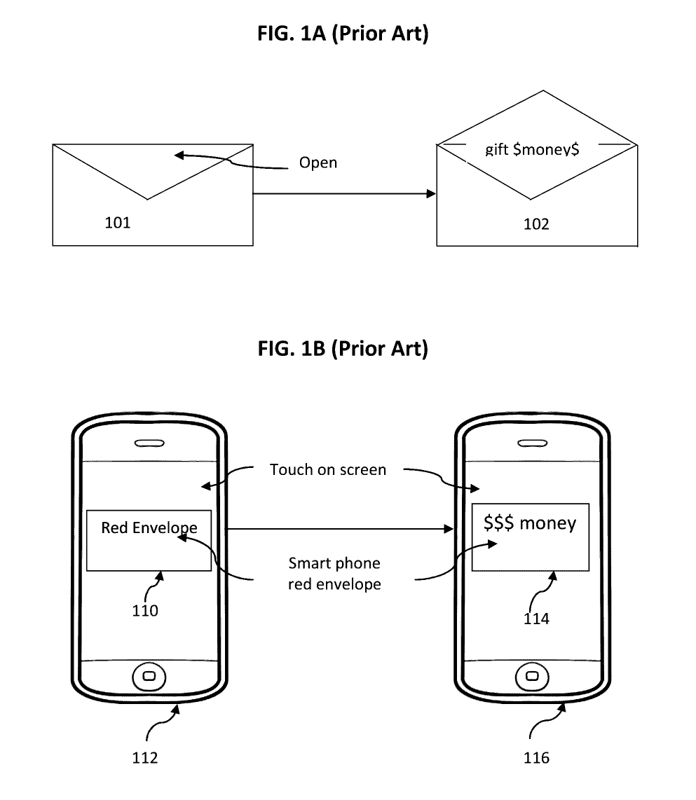

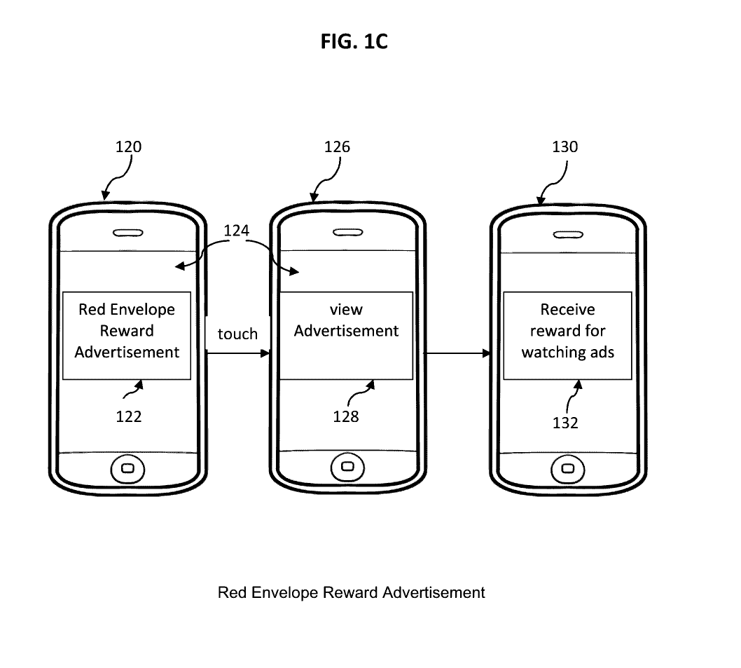

Without intent to limit the scope of the invention, exemplary examples according to the embodiments of the invention are described below in conjunction with the accompanying drawings in FIGS. 1A-1C, 2-4, 5A-5C and 6.

As shown in FIG. 1A, object 101 is a tradition red envelope. In Chinese and other East Asian societies, a traditional red envelope is a monetary gift which is given during holidays or special occasions such as weddings, graduation or the birth of a baby. When recipients open the red envelope as showing in 102, they find cash inside. Chinese companies such as Tencent Holding Ltd. and Alibaba Group Holding Ltd. have developed smart phone app to enable people to send a red envelope via smart phones in a virtual form (or an electronic form). A red envelope on smart phone contains monetary gift like the traditional red envelope. FIG. 1B object 112, 116 is a schematic drawing of screen to illustrate a smart phone version of a red envelope (or an electronic red envelope). People can send red envelope 110 from smart phone to an individual or a social networking group or friends in contact list. Recipients of the red envelope can touch the screen to open the red envelope, monetary gift as shown in object 114 will be deposited the recipients' e-wallet or bank account or the like.

FIG. 1C illustrates an exemplary embodiment of the invention. The main difference between the existing electronic red envelope and the red envelope reward advertisement of the invention is that the red envelope reward advertisement contains advertisement and reward while the prior art only contain monetary gift. For the purpose of illustration, FIG. 1C illustrates an example of the embodiment of the invention on a smart phone in a simplified form. Object 120 shows a smart phone with a red envelope reward advertisement 122 on its screen. People may touch the phone screen 124 to open the red envelope and watch the advertisement 128 as shown on the screen 126. Phone screen 130 displays the reward 132 for opening the red envelope and watching the reward advertisement. The reward can take any of a variety of forms in various implementations such as cash, coupon, gift card, etc. The device can be any type of electronic devices being wirely or wirelessly communicable with the social networking system, such as, but is not limited to, a mobile/cell phone, a smart phone, a smart watch, a personal digital assistant (PDA), a tablet, a laptop, a PC, a game player/box, a smart TV, a TV set top box or entertainment device, a media player, game device, wearable electronics, and the like.

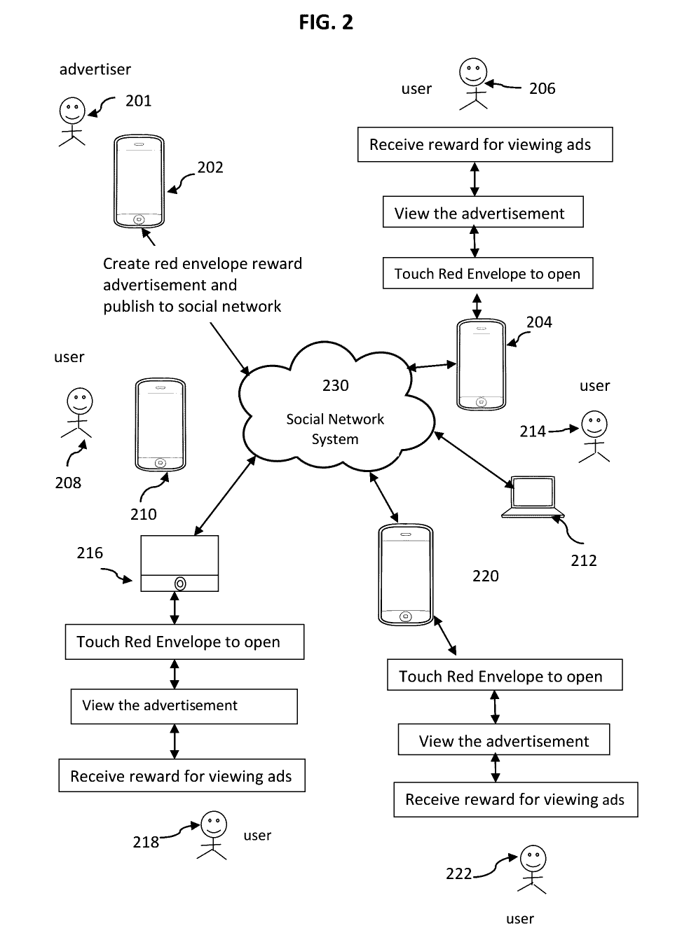

FIG. 2 is a block diagram illustrating one example of the present invention, in accordance with one embodiment. Exemplary system includes an advertiser 201, a social networking system 230, multiple social network users 206, 208, 214, 218, 222, and various devices 202, 204, 208, 212, 216, 220 that are in communication wirely or wirelessly with the social networking system. The diagram shows the interactive relationship among advertisers, the social networking system and the social network users.

Advertiser 201 is a user of the social networking system who creates the red envelope reward advertisement, publishes the ads to the social networking system, pays for the reviewer reward and advertisement expense, receives the result of the advertisement such as total number of the viewers, total number of rewards, total reward claimed and user feedback described herein. Advertiser 201 can represent an individual, business or entity that provides the advertisement contents to the social networking system.

Advertiser 201 uses device 202, creates the red envelope reward advertisement, posts the advertisement to social networking system 230. The social networking system can be a user group or groups such as WeChat®group, Whatsup® group, weibo followers, friend circle, contact list or online community, QQ® group, google+® group, Facebook® friends, Twitter® followers etc.

In some embodiments, an advertiser 201 may post the red envelope reward ads directly to the social networking system 230. While in other embodiments, an advertiser 201 may provide the red envelope reward ads to a social networking system 230 indirectly by using an ads network or ads exchange (not shown).

Social network users receive the red envelope reward advertisement on their device 202, 204, 208, 212, 216, 220. Users 206, 216, 220 who open the red envelope by clicking or touching the screen of the device or other ways detected by the social networking system will have the advertisement showing on their devices. The advertisement can be text, audio, video, picture, logo, and other forms. After viewing the advertisement, the users 206, 216, 220 will receive reward based on predefined amount, and methods by the advertiser or the social networking system. The user 210 and 214 who do not open the red envelope reward advertisement will not receive any reward.

In other implementations, the system may not have all of the components shown and/or may have other elements including other types of elements instead of, or in addition to, those described herein.

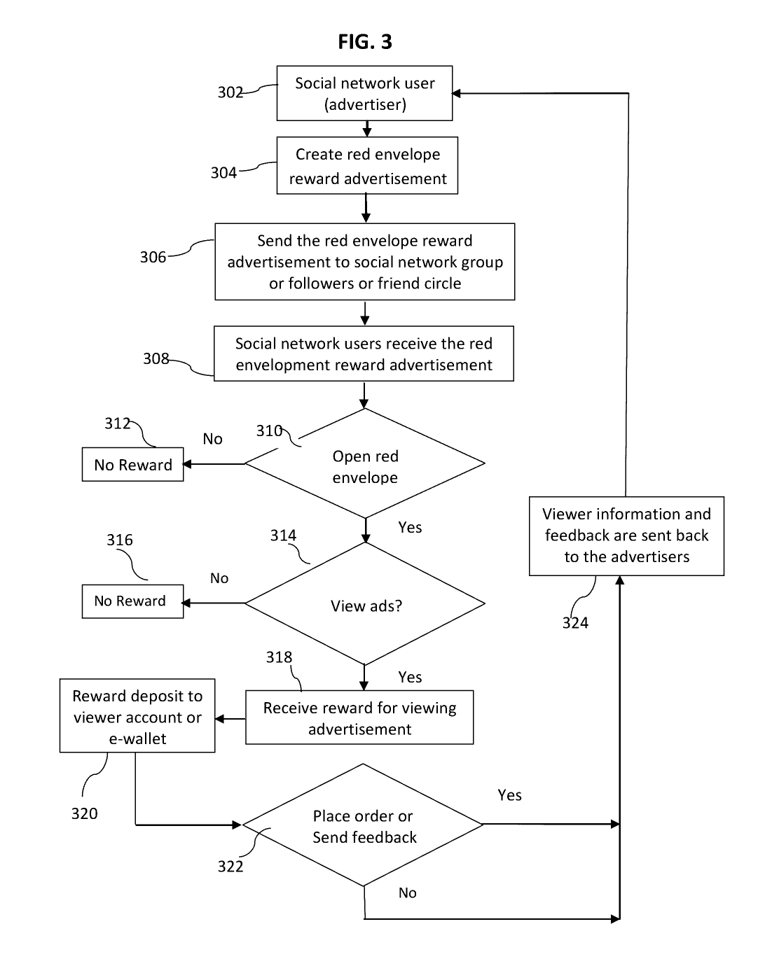

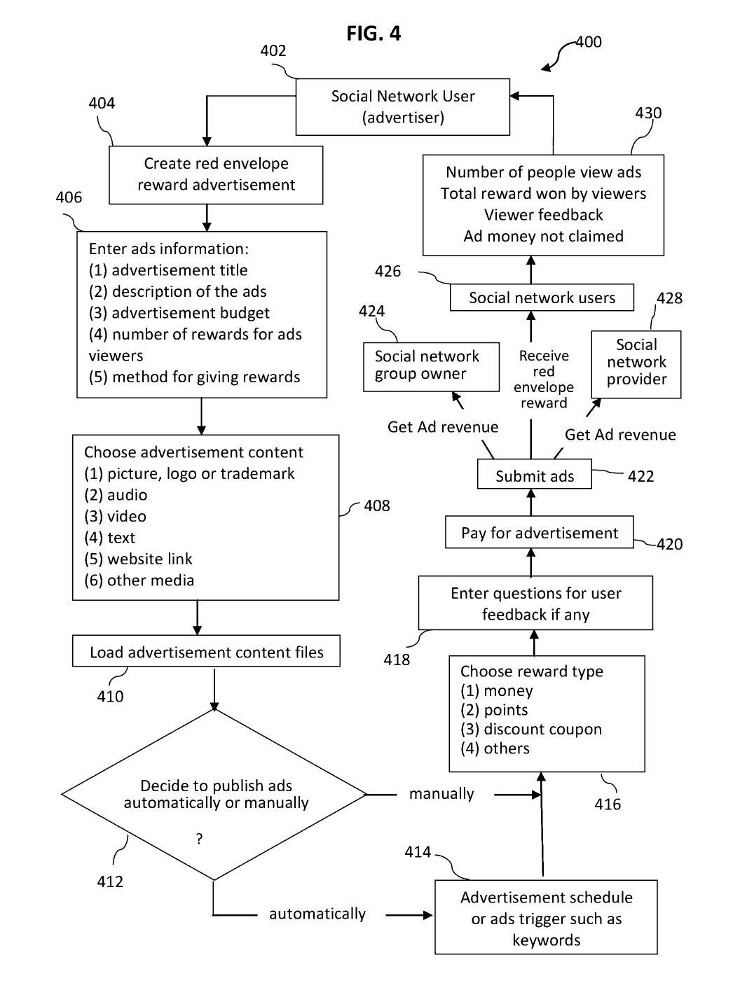

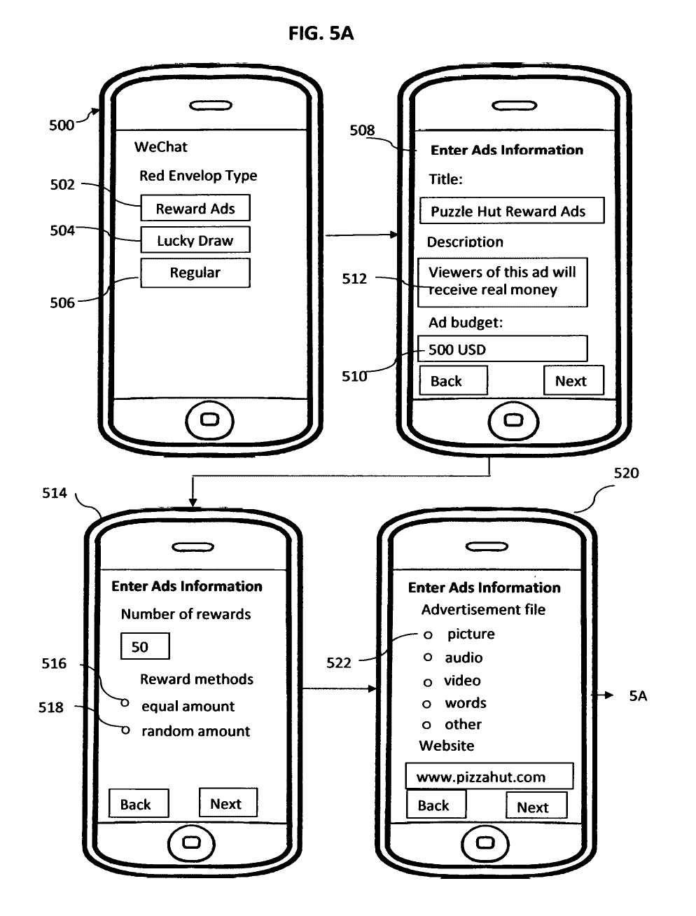

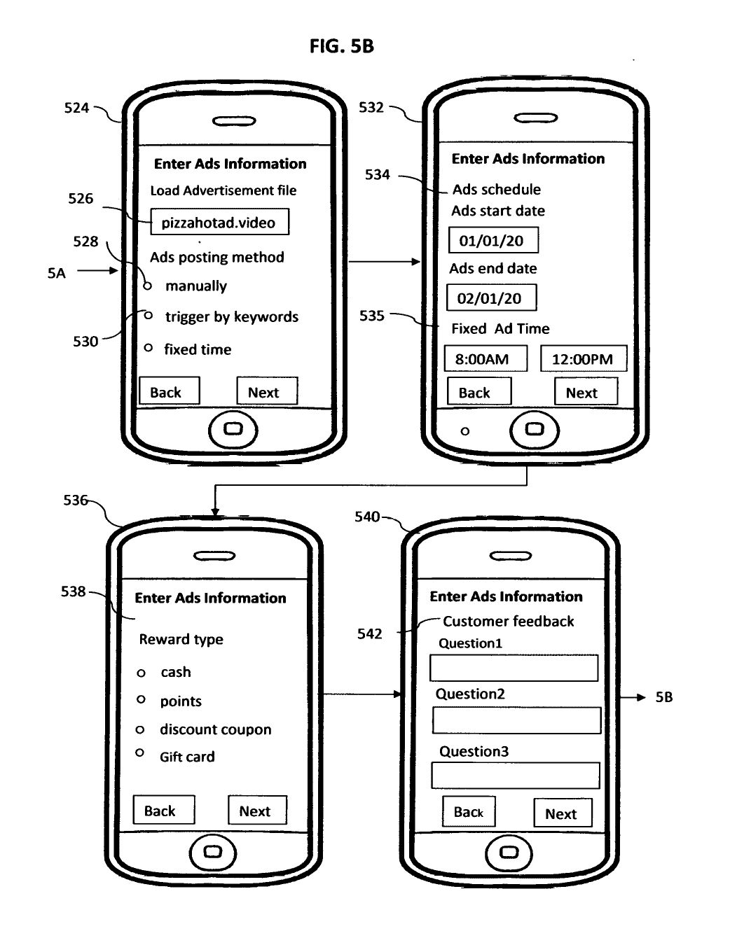

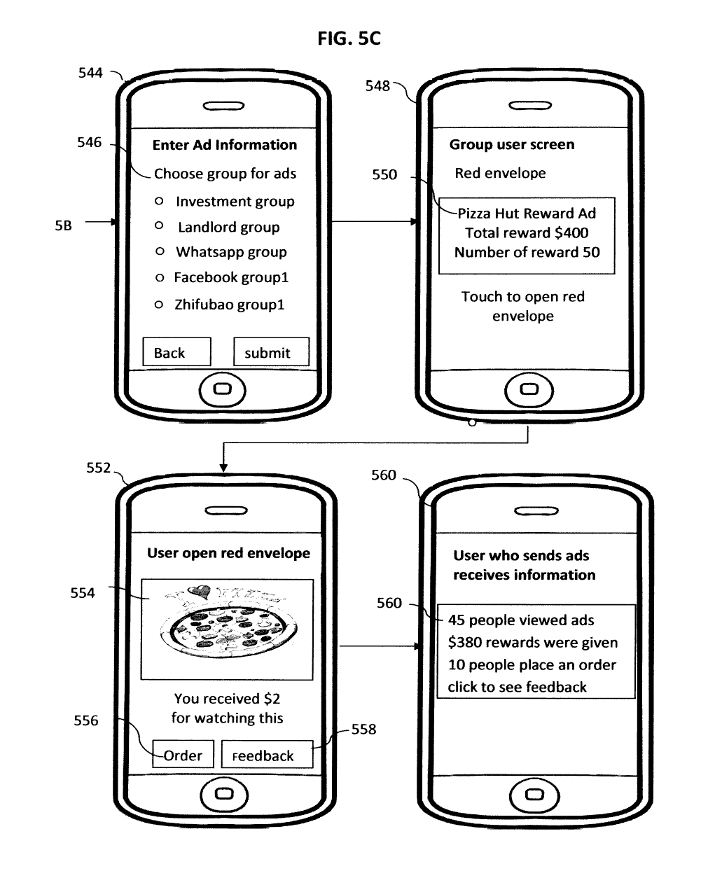

FIG. 3 illustrates a flow diagram of an exemplary process that a red envelope reward advertisement is created and processed in a social networking system, according to one embodiment of the present invention. For the illustration purpose, the flow diagram only shows the steps; the detailed information for each step is further illustrated in FIG. 4 and FIGS. 5A-5C.

In step 302, advertiser is a social network user who wants to create and publish red envelope reward advertisement. In step 304, the advertiser can create the red envelope reward advertisement by using the present inventory. Then, the advertiser in step 306 can post the red envelope reward advertisement to a social networking system such as WeChat®, Line, Facebook®, Whatsup®, etc. For example, WeChat® advertiser who does roof repair can post the red envelope reward advertisement to WeChat® housing group where house repair issues are frequently discussed.

Social network users in those groups may receive the red envelope reward advertisement as shown in step 308. In one exemplary of the embodiment of the present inventory, a red envelope is displayed on the smart phone screen of the WeChat® users. It is the users' decision that they want to open the red envelope and view the advertisement.

In step 310, if the social network user does not open the red envelope and not view the advertisement, no reward is given to the user as showing step 312. If the user opens the red envelope, but does not view the advertisement, no reward is given to the user in step 316. If the user opens the advertisement and views the advertisement, the user receives reward for watching the ads as showing in step 318.

In step 320, the reward is given to the user. Users can deposit the rewards into their account or e-wallet or bank account, etc. For example, WeChat® users can have the reward deposited into their WeChat® wallet. Some users may choose to order the products or service or visiting the websites provided in the advertisement in step 322; and some users may send feedback on the advertisement and/or products and/or services to the advertiser.

At the end step 324, the data of the advertisement such as how many users watch the ad, how many people receive rewards, the total amount of the reward is given, the amount of reward each user receives, feedback from viewers, who visits the website or places order, etc may be collected and sent to the advertiser for evaluation, improvement and planning.

FIG. 4 is a flow diagram illustrating a red envelope reward advertisement creation and publishing method 400 according to an exemplary embodiment.

In some implementations, some or all of the method 400 can be implemented on one or more devices. Method 400 can be implemented by program instructions or code, which can be implemented by one or more processors, such as microprocessors or other processing circuitry and can be stored on a computer readable medium, such as a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. Alternatively, these methods can be implemented in hardware (logic gates, etc.), or in a combination of hardware and software. The method 400 can be provided as part of or component of an application running on the device, or as a separate application or software running in conjunction with other applications and operating system.

Block 402 is a social network user who wants to create and post a red envelope reward advertisement to a social networking system. The social network user can be called advertiser. The advertiser has connection to social network users such as user groups, friend circle, followers, contact list, online community, microblogs, etc as shown in FIG. 2.

In block 404, the advertiser starts the process to create a red envelope reward advertisement. The advertisement content may be provided by the advertiser itself, other individual, business, organization, entity and the like. The advertiser can enter the advertisement information to the social networking system. In some implementation as shown in block 406, the information includes the title of the advertisement such as “Pizza Hut Red Envelope Ads”, a short description of the advertisement such as “Spring break buy one get one free special”, the total budget of this advertisement, the total number of rewards for social network users who open the red envelope reward advertisement and view the advertisement, also the method in which that reward is distributed to the ads viewers. In some implementations, users who view the advertisement get equal amount of reward predetermined by the advertiser. In other implementation, method such as lucky drawing is used, the amount of each reward is generated randomly by the social networking system.

In block 408 of method 400, the advertiser provides advertisement content format. The content constitutes digital data and can be any type of content, such as text, image, video, audio, or a combination of these or other types. In some embodiments, the content can include other information such as website, geographical locations, map information, logo, trademark, biometric information, etc.

In block 410 of method 400, The content can be uploaded into the social networking system or an advertiser's device, and stored on one or more storage devices accessible to the social networking service, such as on the social network database. Some implementations allow the providing user to upload the content to a user profile or account associated with the providing user in the social networking service.

In block 412, the advertiser can choose the method to publish the red envelope reward advertisement to the social networking system. In some implementations, the red envelope reward advertisement is posted manually to the social networking system by the advertiser. In other implementations, the advertisement can be automatically published to the social networking system based specified schedules entered in block 414. For example, the advertisement is posted to “runners club” WeChat® group at 5 PM every Saturday. In another implementations, the red envelope reward advertisement can be automatically published based on one or more criteria such as keywords defined by the advertiser, or keywords are within the category. For example, when a keyword “pizza” is mentioned in a WeChat® group “Food Lovers”, the red envelope reward advertisement is posted to the WeChat® group automatically.

In block 416, the advertiser chooses the type of reward giving to user who open the red envelope reward advertisement and view the advertisement. The reward can take any of a variety of forms in various implementations. For example, the reward can be an amount of monetary value, such as cash, and/or can be a form of exchange in other or additional forms, such as a bitcoin or system-limited currency, exchangeable tokens or credits, points, IOUs, discount or redeemable coupons, gift card, etc. The reward can be an item, product or service, such as one or more free physical products, virtual bonuses or products having value within a computer-implemented environment, free use of a service for a particular length of time, or other form of reward. The reward can be provided in a virtual form, such as virtual currency, credits, or items, or in a physical form, such as physical money or products.

In block 418, the advertiser can enter questions or survey forms for user feedback. In some implementation, the questions or survey form will be presented to the users after they open the red envelope reward advertisement and view the advertisement. The feedback can be a measure of the effectiveness of the advertisement or customer feedback on the advertised product or services. For example, user is required to touch the “finish” button on the smart phone screen at the end of the advertisement to show they have watched the video before receiving reward. In another exemplary implementation, the user may be required to scratch-off a virtual cover on the smart phone screen to see the amount of the reward they receive, which is similar to scratch off the cover to find the pin number on a gift card.

In block 420, the advertiser may pay for posting the red envelope reward advertisement to a social networking system. The payment might also include the expense of the rewards such as cash rewards, free product or service rewards and bonus for customer feedback, etc. The payment may be made in the various ways. In one exemplary embodiment of the invention, the payment can be made with the advertiser's e-wallet such as apple-pay account or zhifubao account, WeChat® wallet, paypal account, etc. In another exemplary embodiment of the invention, the payment can be made with bank account, credit card and pre-arranged contract payment, etc.

In block 422, the advertiser submits all information to social networking system. The red envelope reward advertisement will be posted to advertiser selected social networking system or groups or online community such as WeChat® user group, Facebook® followers, QQ® groups, friend circles, Whatsup® groups, Line® groups, etc.

After the submission of all the information in block 422, the exemplary method 400 will process the advertisement information and payments. In one embodiment of this invention, the total payment may be split into different portions based on predefined advertisement revenue allocation rule such as contract. Part of the advertisement may be used as rewards for social network users who open the red envelope reward advertisement and view the ads as shown in block 426. The reward method and amount are predetermined by advertiser in block 404. Another part of the advertisement payment may be paid to the user or users who create the groups or social network circles as shown in block 422. Another part of the advertisement payment may be paid to social networking system provides as shown in block 424. For example, the advertiser pays $1000 for posting the red envelope reward advertisement to WeChat® “landlord group”, $900 of the $1000 is used as a reward for social network users who open the red envelope and view the advertisement. $50 of the $1000 will be pay to the WeChat® which provides the social networking system. $50 of the $1000 may be paid to the WeChat® users who create and/or manage the “landlord group”.

In block 430, the red envelope reward advertisement result data may be collected and stored in the social networking system database or storage for advertiser to obtain. In one embodiment of this invention, the data may include the number of social network users who open the red envelope reward advertisement and view the advertisement, the total number of rewards is given, the total amount of the reward is given and the amount of each reward. The data may also include the viewer feedback information entered in block 418. All the information in block 430 may be send back to the advertiser in block 402.

FIGS. 5A-5C are a serial of block diagrams illustrating an exemplary embodiment of the present invention. For ease illustration purpose, a smart phone screen is used to show the red envelope reward advertisement creation and publishing process with graphic user interfaces. The described features, structures, or characteristics of the embodiment may be implemented in other devices such as computer, tablet computer, PDA, wearable electronic, game device, TV or the like without departing from the spirit and scope of the invention. It should be appreciated that the embodiments described herein are illustrated by referring to currently-prevalent social networking system such as WeChat®, the application of these embodiments are not so limited, but can include any type of existing social networking platforms such as QQ®, Whatsup®, Snapchat®, Facebook®, Twitter®, Line®, Skype® or future social networking platforms that people may adopt in view of the continuous evolvement of technologies. Numerous specific details are recited to provide a thorough understanding of embodiments of the invention. One skilled in the relevant art will recognize however, that the invention may be practiced without one or more of the specific details.

Block 500 in FIG. 5A is a smart phone with WeChat® application. Object 504 and Object 506 are the two existing WeChat® red envelope apps. Object 504 “Regular Red Envelope” allows user to specify the amount of the money to give. Regular red envelope can be sent to an individual or WeChat® group, recipients will split amount of money equally. Object 506 “Lucky Draw Red Envelope” may be sent to an individual or WeChat® group, recipients will receive an amount of money randomly assigned by WeChat® red envelope based on the information user entered at the time of red envelope creation. Object 502 “Red Envelope Reward Advertisement” shows an exemplary of embodiment of the present invention. Red envelope reward advertisement can be implemented as one of WeChat® apps; it enables WeChat® user to send advertisement to various WeChat® groups, and share ads in personal moment and friend circle. People who open the red envelope and view the advertisement will receive reward for viewing the advertisement.

Block 508 shows an interface that a WeChat® user can enter the information of the red envelope reward advertisement. For example, a Pizza Hut advertisement, the title of the advertisement, the description of the advertisement, the total payment for the advertisement are entered. Object 510 and Object 512 are navigation buttons allows user to go back and forward to the previous or next screen. More information such as the total number of the rewards is entered on Block 514. Object 516 and Object 518 determine the method to allocate the reward to viewers. If “equal amount” is chosen, the reward amount is the total reward amount divided by the total number of the reward. If “random amount” is chosen, the amount of each reward is generated randomly by WeChat®.

Block 520 allows WeChat® user to select the type of the advertisement content file. In some implementation of the embodiment, the advertisement content file can be a picture, audio, text, video file. A website address, a logo, trademark, or map may also be entered to display with the advertisement.

Continuing 5A after block 520 shown in FIG. 5A, block 524, as shown in FIG. 5B, shows a screen that user may upload the advertisement content file 526 and choose a method 528 and 530 that red envelope reward advertisement is posted to WeChat® group, WeChat moment and friend circle. WeChat® users may manually post the red envelope reward advertisement to particular WeChat® groups at the time they choose. Or WeChat® system may automatically posts the red envelope reward advertisement at fixed time as shown in object 535 or the posting is automatically triggered by a keyword or keywords in the WeChat® group conversation. The advertisement schedule 534 may be entered in screen 532.

In block 536, the types of rewards are listed in an exemplary of the embodiment. The rewards are for WeChat® users who open the red envelope and view the advertisement. The reward can be, for example, cash, point, a gift card, store credit, a discount coupon for a product or service, cyber money, or other rewards. The WeChat® advertiser may also want some feedback from the advertisement viewers. Feedback questions or survey may be setup at block 510.

Continuing 5B after block 540 shown in FIG. 5B, block 544 as shown in FIG. 5C, may provide WeChat® advertiser with multiple optional channels 546 for posting the red envelope reward advertisement. The advertiser may post the advertisement to one or more WeChat® user groups or friend circles or other social networking system such as Line®, Facebook®, Twitter®, Linked In®, Weibo®, QQ space®, Skype®, etc.

Once the red envelope reward advertisement is delivered to the social network users, the users may see an object 550 on their device 548. In an exemplary of the embodiment of the invention, the red envelope may show the advertisement title and content, the amount, number and type of the rewards. For example, Pizza Hut Reward Advertisement, the total amount of reward is $400 cash for people who view the advertisement, the total number of rewards are 50, if reward method is equal amount as illustrated in Object 516 block 514, each viewer receive $8 if they open the red envelope reward advertisement and view the advertisement as shown in block 552. User may choose to open the red envelope reward advertisement or may choose to ignore the red envelope if the advertisement is not in his/her interest.

In the current example block 552, a PizzaHut pizza advertisement is used an exemplary of the embodiment, the content of the advertisement may be displayed in the format of audio, video, text, picture, logo, trademark, game, or combined or other forms. Ads viewers may be required to respond in the middle or at the end of the advertisement to show that they are indeed watching the advertisement. A button or URL link 556 may be used to direct viewers to a website or system for ordering the products or services or checking out detailed information. Viewers may also send back their feedback to the advertiser by pressing button 558.

Block 562 on screen 560 displays the viewership information of the red envelope reward advertisement, according to an exemplary of embodiment of the inventory. The advertiser can obtain information, for example, how many people open and view the advertisement, how many rewards are claimed, how many people go to the order/detail website, also the viewer feedback. The information can be stored into social networking system or storage or disk for further analysis.

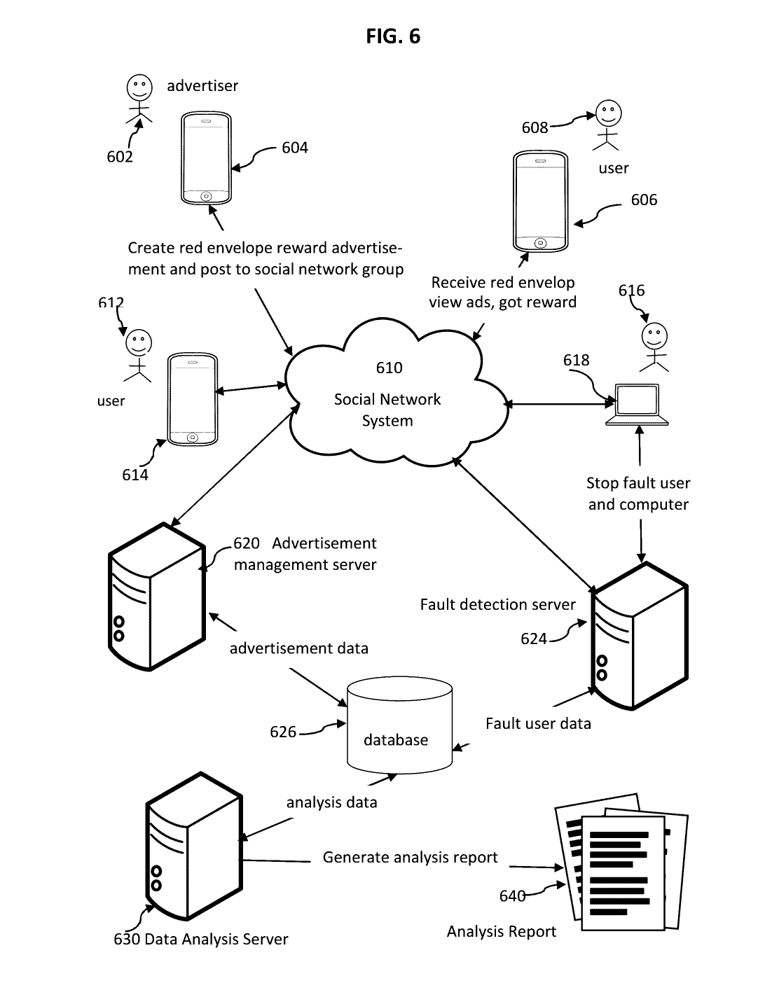

FIG. 6 illustrates a block diagram of an example social networking system. In some implementations, the system includes one or more server systems to provide one or more features described herein. For example, the system shown in FIG. 6 consists of a social networking system 610, a red envelope reward advertisement management server 620, a fault detection server 624, a data analysis server 630 and database 626 or other storage device, also some social network users 602, 608, 612, 616 and user devices 604, 606, 614,618. The devices may communicate with each other via network. Network can be any type of communication network, including one or more of the Internet, local area networks (LAN), wireless networks, switch or hub connections, etc.

Server blocks 610, 620, 624, 630 and database 626 may represent multiple systems, server devices, and network databases, and the blocks can be provided in different configurations than shown. Also, there may be any number of client devices. Each client device can be any type of electronic device, such as a computer system, portable device, cell phone, smart phone, tablet computer, television, TV set top box or entertainment device, personal digital assistant (PDA), media player, game device, etc. In other implementations, social networking system may not have all of the components shown and/or may have other elements including other types of elements instead of, or in addition to, those described herein.

Social network user, for example, advertiser 602, may want to create red envelope reward advertisement and post it to a social networking group, friends circle, etc. In an exemplary of the embodiment of the invention, the advertisement information is sent to social network servers, the social network servers may have an advertisement manager server 620 to process and manage the advertisement content, files, schedule, ads distribution channel, advertiser, reward types, reward amount, website/link, viewer survey, viewer feedback, etc. The data may be stored in database 626. Advertiser 602 or other users with access permission can retrieve, modify the information for manual posting or automatic posting based on options 528 of FIG. 5B.

Vicious behaviors or attacks may happen in social networking system to damage the fairness and effectiveness of the red envelope reward advertisement process. For example, social network user 616 can false claim red envelope advertisement reward using software. In some implementation, a fault protection server or servers may use to detect vicious behaviors and attacks to restrict the access of social network user or users and their devices 618. The fault user information may be stored into database 626 to limit the user 616 to participate future activities. Social network users who post advertisement with illegal content may also be prohibited to post advertisement once detected fault detection server system.

Block 630 is a data analysis server. In some implementations of the present invention, the advertisement data, reward claims, user feedback data, ads survey data, fault user data stored in database 626 can be analyzed using statistical, mathematical, data mining, big data analysis or other methods. The effectiveness of the red envelope reward advertisement can be learned from data analysis result. Analysis result may be used to predict or improve future advertisements and the social networking systems. Analytical report 640 may be generated for advertisers, social network providers and people who are interested.

The description of the embodiments has been presented for the purpose of illustration; it is not intended to be exhaustive or to limit the disclosure to the precise forms disclosed. Persons skilled in the relevant art can appreciate that many modifications and variations are possible in light of the above disclosure.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. A social networking interface, including display of content and communications, privacy settings, notifications, and other features described herein, can be displayed using software on the client device, such as application software or client software in communication with the server system. The interface can be displayed on an output device of the client device, such as a display screen. For example, in some implementations the interface can be displayed using a particular standardized format, such as in a web browser or other application as a web page provided in Hypertext Markup Language (HTML), Java™, JavaScript, Extensible Markup Language (XML), Extensible Stylesheet Language Transformation (XSLT), and/or other format. Other implementations can use other forms of network systems instead of social networking services and systems. For example, a set of users and other entities using any computer network can make use of features described herein.

Variations can be implemented without departing from the spirit of this inventory. It should be noted that the blocks described herein can be performed in a different order than shown and/or simultaneously (partially or completely) with other blocks, where appropriate. In some implementations, blocks can occur multiple times, in a different order, and/or at different times in the methods. In other implementations, variations of one or more above features can be used. For example, the red envelope can be in different colors, shapes than shown in the above description and drawing.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon.

Accordingly, the disclosure of the embodiments is intended to be illustrative, but not limiting, of the scope of the disclosure, which is set forth in the following claims.

What is claimed is:

1. A method for a red envelope reward advertisement, comprising:
creating a red envelope reward advertisement containing advertisement content and a red envelope;
publishing the red envelope reward advertisement to a social network system;
identifying users of the social network system who access and view the advertisement content of the red envelope reward advertisement; and
rewarding each user who accesses and views the advertisement content from the red envelope of the red envelope reward advertisement.

2. The method of claim 1, wherein the advertisement content comprises at least one of one or more logos, one or more trademarks, one or more pictures, one or more audios, one or more videos, one or more depictions, and one or more website links, referring to one or more products or services.

3. The method of claim 1, wherein the red envelope comprises at least one type of rewards including cashes, points, discount coupons, gift cards, free products or services, IOU, bitcoin, virtual money, and the like, and an amount of rewards for each user who access and view the advertisement content.

4. The method of claim 3, wherein the red envelope reward advertisement contains a notice of which the red envelope is rewarded only to users who access and view the advertisement content.

5. The method of claim 4, wherein rewarding each user who accesses and views the advertisement content comprises rewarding each user who accesses and views the advertisement content with the amount of rewards.

6. The method of claim 5, wherein rewarding each user who accesses and views the advertisement content comprises depositing the amount of rewards to an account or e-wallet of the user.

7. The method of claim 1, further comprising rewarding each user who places a purchase order after accessing and viewing the advertisement content.

8. The method of claim 1, further comprising rewarding a service provider of the social network system when a user accesses and views the advertisement content.

9. The method of claim 1, further comprising sending information of user access and view and user feedback of the red envelope reward advertisement to an advertiser of the red envelope reward advertisement, by a service provider of the social network system.

10. The method of claim 1, wherein creating the red envelope reward advertisement is performed by an advertiser, in a client device.

11. A system for a red envelope reward advertisement, comprising:
a storage medium; and
one or more processors accessing the storage medium and operative to perform operations comprising:
creating a red envelope reward advertisement containing advertisement content and a red envelope;
publishing the red envelope reward advertisement to a social network system;
identifying users of the social network system who access and view the advertisement content of the red envelope reward advertisement; and
rewarding each user who accesses and views the advertisement content from the red envelope of the red envelope reward advertisement.

12. The system of claim 11, wherein the advertisement content comprises at least one of one or more logos, one or more trademarks, one or more pictures, one or more audios, one or more videos, one or more depictions, and one or more website links, referring to one or more products or services.

13. The system of claim 11, wherein the red envelope comprises at least one type of rewards including cashes, points, discount coupons, gift cards, free products or services, IOU, bitcoin, virtual money, and the like, and an amount of rewards for each user who access and view the advertisement content.

14. The system of claim 13, wherein the red envelope reward advertisement contains a notice of which the red envelope is rewarded only to users who access and view the advertisement content.

15. The system of claim 14, wherein rewarding each user who accesses and views the advertisement content comprises rewarding each user who accesses and views the advertisement content with the amount of rewards.

16. The system of claim 15, wherein rewarding each user who accesses and views the advertisement content comprises depositing the amount of rewards to an account or e-wallet of the user.

17. The system of claim 11, wherein the operations further comprises rewarding each user who places a purchase order after accessing and viewing the advertisement content.

18. The system of claim 11, wherein the operations further comprises rewarding a service provider of the social network system when a user accesses and views the advertisement content.

19. The system of claim 11, wherein the operations further comprises sending information of user access and view and user feedback of the red envelope reward advertisement to an advertiser of the red envelope reward advertisement, by a service provider of the social network system.

20. A non-transitory computer-readable medium storing instructions which, when executed by one or more processors, cause a system to perform operations comprising:
creating a red envelope reward advertisement containing advertisement content and a red envelope;
publishing the red envelope reward advertisement to a social network system;
identifying users of the social network system who access and view the advertisement content of the red envelope reward advertisement; and
rewarding each user who accesses and views the advertisement content from the red envelope of the red envelope reward advertisement.
